(19) United States
(12) Patent Application Publication
(10) Pub. No.: US 2015/0264418 A1
(43) Pub. Date: Sep. 17, 2015

(54) ADVERTISEMENT FILTERING AND TARGETING THROUGH USER-PREFERENCES

(71) Applicant: Cisco Technology, Inc., San Jose, CA (US)

(72) Inventors: Philip Clifford Jacobs, Windham, NH (US); Randy Sisk, Austin, TX (US)

(21) Appl. No.: 14/721,946

(22) Filed: May 26, 2015

Related U.S. Application Data
(63) Continuation-in-part of application No. 11/861,513, filed on Sep. 26, 2007.

(51) Int. Cl. H04N 21/2668; H04N 21/234; H04N 21/475; H04N 21/258; H04N 21/81

(52) U.S. Cl. CPC H04N 21/2668; H04N 21/25891; H04N 21/812; H04N 21/4755; H04N 21/4758; H04N 21/23424

(57) ABSTRACT

A method for targeting and filtering advertisements in a communication network includes querying a viewer for a response indicating a preference setting for provision of advertisements, and receiving from the viewer a response to the query indicating the preference setting for provision of advertisements. The preference setting includes a relevancy threshold setting indicating how closely the viewer's preference for certain advertisements are to be followed and a set of preferences for advertisements of certain types. The method further includes providing display content to a display device associated with the viewer, including a first component having a main content portion, and a second component distinct from the first component, the second component having advertisements that closely match the set of preferences for advertisements of certain types Software and hardware apparatus embodiments are provided as well.

### CROSS-REFERENCE TO RELATED APPLICATION

This application is a continuation-in-part of U.S. application Ser. No. 11/861,513, filed Sep. 26, 2007, the content of which is herein incorporated by reference in its entirety.

### TECHNICAL FIELD

The present disclosure relates generally to advertising, and more particularly to advertisement filtering and targeting.

### BACKGROUND

In a post Internet world, consumers are presented with ever increasing access to digital content. Indeed, consumers can often access such digital content using multiple devices such as mobile devices, tablets, laptops, and the like. In addition, more than a few businesses leverage advertisements as a cost to access their digital content. However, a combination of ever increasing access to digital content with businesses that leverage advertisements creates an apathetic consumer environment. As a result, consumers or viewers of advertisements (e.g., banners ads on web pages, commercials on television, video advertisements presented before or during main video presentations) often do not pay attention to the advertisements because the advertisements are too numerous and are of insufficient relevance to the viewer. In addition, the prevalence of video recording devices allows viewers to fast-forward through video advertisements. Similarly, the prevalence of ad-blocking software allows viewers to view web pages without seeing the banner ads.

Various advertising schemes have been used to encourage viewers to view advertisements, however such advertising schemes often fail to adequately target and engage viewers. For example, in one technique, a web site collects information about the products previously bought by a user, and targets banner advertisements to that user based on the types of products that the user has purchased. In another technique, a web site collects information about the web pages viewed by the user, and targets banner advertisements to that user based on the types of web pages that the user has viewed. In another technique, a web site presents a user with banner advertisements based on search query terms entered by the user for a web search. In another technique, a user watches a movie, but advertising before or during the movie is presented in a mode that prevents the user from fast-forwarding through the advertisements.

### BRIEF DESCRIPTION OF THE DRAWINGS

Objects, features and advantages will be apparent from the following description of particular embodiments of the invention, as illustrated in the accompanying drawings in which like reference characters refer to the same parts throughout the different views. The drawings are not necessarily to scale, emphasis instead being placed upon illustrating the principles of various embodiments of the invention.

FIG. 1 illustrates an example system for use in practicing one embodiment of this disclosure.

FIG. 2 illustrates an example video timeline that may be produced by one embodiment of this disclosure.

FIG. 3 illustrates an example web page as displayed on a display screen in one embodiment of this disclosure.

FIG. 4 illustrates an example Graphical User Interface of one embodiment of this disclosure.

FIG. 5 illustrates a method employed by one embodiment of this disclosure.

### DETAILED DESCRIPTION

### Overview

Provided is a description of various embodiments which provide for improved method, computer program product, and apparatus for advertisement filtering. In these embodiments, a viewer is given more control over the advertising that he or she sees.

One embodiment is directed toward a method in which a viewer is queried for a preference setting for provision of advertisements, the viewer responds to the query with a preference setting for provision of advertisements, and advertising is provided to the viewer in accordance with the received preference setting, together with main content.

Other embodiments are directed to a computer program product and to an apparatus which perform a similar method.

### Description of Example Embodiments

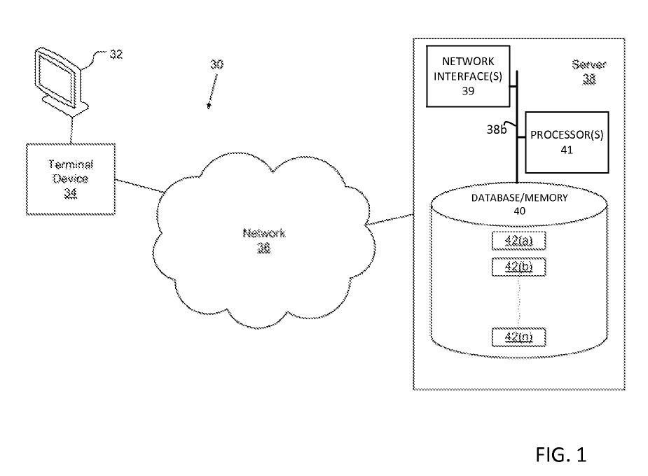

FIG. 1 illustrates an example system 30 over which embodiments of this disclosure may be practiced. Referring to FIG. 1, system 30 includes a display device 32 connected to a terminal device 34. Display device 32 includes a display viewed by an associated user or viewer (not shown). Terminal device 34 further connects to a server 38 over a network 36.

Network 36 includes, for example, a communication network of geographically distributed nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC) such as IEEE 61334, IEEE P1901.2, and others. The communication links, which connect terminal device 34 to server 38 can include wired links or shared media (e.g., wireless links, PLC links, etc.). Those skilled in the art will understand that any number of nodes, devices, links, etc. may be used in the communication network, and that the view shown herein is for simplicity. Also, those skilled in the art will further understand that while communication network 36 is shown in a certain orientation, such view is merely an example illustration that is not meant to limit the disclosure.

Terminal device 34 and server 38 may exchange data packets (e.g., traffic and/or messages sent between the devices/nodes) using predefined network communication protocols such as certain known wired protocols, wireless protocols (e.g., IEEE Std. 802.15.4, WiFi, Bluetooth®, etc.), PLC protocols, or other shared-media protocols where appropriate. In this context, a protocol consists of a set of rules defining how the nodes interact with each other.

Server 38, as shown, includes one or more network interfaces 39 (e.g., wired, wireless, PLC, etc.), at least one processor 41, and a memory 40 or database 40 interconnected by a system bus 38b.

Network interface 39 contains the mechanical, electrical, and signaling circuitry for communicating data over links coupled to network 36. Network interfaces 39 may be configured to transmit and/or receive data using a variety of different communication protocols. Note, further, that the nodes may have two different types of network connections 210, e.g., wireless and wired/physical connections, and that the view herein is merely for illustration.

Database or memory 40 comprises a plurality of storage locations (e.g. labeled as 42(a)-42(n)) addressable by processor 41 and the network interfaces 39. The storage locations can store, for example, software programs as well as data structures (e.g., display content such as main video content, advertisements, and the like) associated with the embodiments described herein. Note that certain devices may have limited memory or no memory (e.g., no memory for storage other than for programs/processes operating on the device and associated caches).

Processor 41 includes hardware elements or hardware logic adapted to execute the software programs (e.g., filtering and targeting processes/services) and also manipulate data or content stored in storage locations 42(a)-42(n). Here, the storage locations 42(a)-42(n) may generally refer to advertisement data 42 or advertisement content.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while certain processes may be described separately, those skilled in the art will appreciate that processes may be routines or modules within other processes.

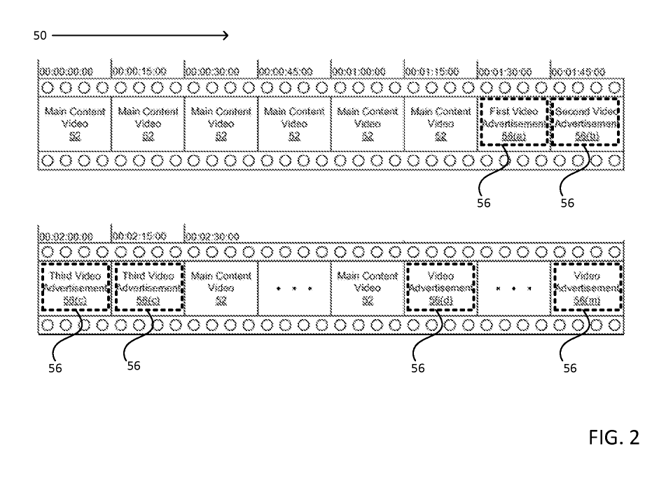

Referring now to FIG. 2, advertisement data 42 includes pre-recorded video advertisements. As shown, a timeline 50 represents a stream of video, segmented in 15 second time increments, to be displayed by, for example, display device 32.

At time index 00:00:00:00 (representing 0 hours, 0 minutes, 0 seconds, and 0 frames into the video stream), main content video 52 is displayed by display device 32 (e.g., delivered to the user or viewer of display device 32). This main content video 52 may be, for example, a television show or a movie, but it may not be an advertisement. This main content video 52 remains displayed for an interval of time.

At some point—here, time index 00:01:30:00—main content video 52 is replaced with a video advertisement 54. Notably, video advertisement 54 may be composed of one or more video advertisements 56(a), 56(b), . . . , 56(m) (generally referred to as video advertisements 56). As depicted, three video advertisements 56 are shown before main content video 52 resumes (e.g., first video advertisement 56(a), second video advertisement 56(b), and third video advertisement 56(c)). First video advertisement 56(a) is displayed on screen for 15 seconds, second video advertisement 56(b) is displayed on screen for 15 seconds, and third video advertisement 56(c) is displayed on screen for 30 seconds. Thus, main content video 52 resumes at time index 00:02:30:00, after which periods of main content video 52 and video advertisements 56 may alternate.

In operation, terminal device 34 and/or display device 32 may request main content video 52 from database 40 (or another database) over network 36. Processor 41 receives such request, retrieves the main content video 52 from database 40 (or another database) and transmits the main content video 52 to terminal device 34 and/or display device 32 for subsequent display. Processor 41 and database 40 also cooperate to retrieve and transmit advertisement data 42 to terminal device 34 and/or display device 32 according to the advertisement filtering and targeting techniques disclosed herein.

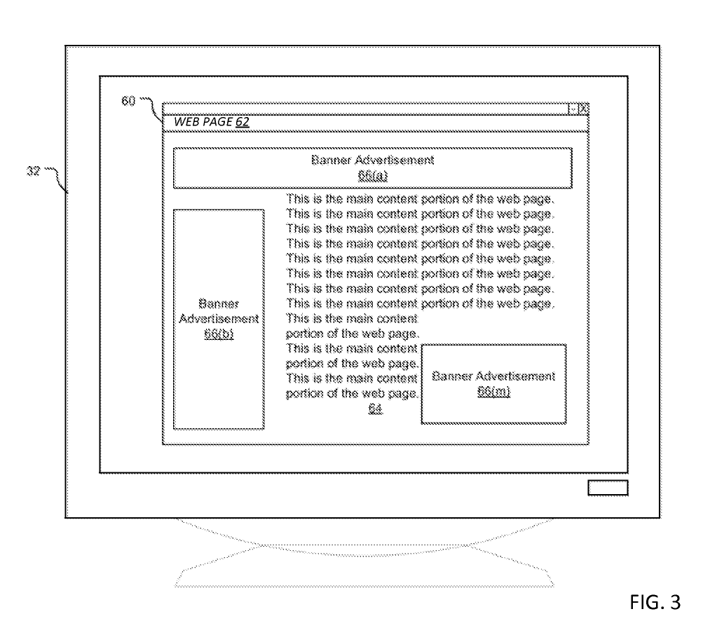

In another embodiment, represented in FIG. 3, the advertisement data 42 includes banner content for display on web pages. For example, display device 32 can include a graphical user interface (GUI) such as a display window 60 that includes a web page 62. The web page 62 contains a main content portion 64, as well as an advertising portion 66, including one or more banner advertisements 66(a), 66(b), . . . , 66(m). This main content portion 64 may contain any content normally found on a web page, but it does not include any advertisements.

In another embodiment, the advertisement data 42 is displayed on a first web page. This first web page generally does not have any main content. After the viewer has seen the advertisements on the first web page, the viewer is then permitted to see a second web page containing the main content portion 64.

In general, the term “main content” refers to any content, excluding advertising, which provides value to a viewer. Thus, on a web page containing review of cars, the car reviews are part of the main content. However, advertisements presented on that same page, paid for by a car manufacturer or a car dealer, would qualify as advertisements rather than as main content. It should be noted, however, that in rare cases content which might otherwise be classified as an advertisement could be considered to be main content, but only if specifically requested by a viewer. For example, a viewer wishes to see video clips of the television commercials presented during the 2007 Superbowl, because the viewer wishes to decide which advertisement was the best one presented. Thus, a viewer may visit a web site devoted to displaying video clips of such advertisements, and the viewer may request to see a particular video clip of such an advertisement. In such a (rare) case, the video clip of the requested advertisement is to be considered main content.

An “advertisement” is defined to be a promotion of a good, service, or company. The advertisement must be paid for by the company or a seller of such good or service.

In one embodiment, the terminal device 34 is a computer. In another embodiment, the terminal device 34 is a set-top box for a cable television system. In either case, the terminal device 34 may include hardware and software operating in conjunction to perform the techniques described below. Such hardware and software, can include, for example, one or more processors, network interfaces, memory, data structures, and the like.

In one embodiment, the display device 32 is a computer monitor. In another embodiment, the display device 32 is a television.

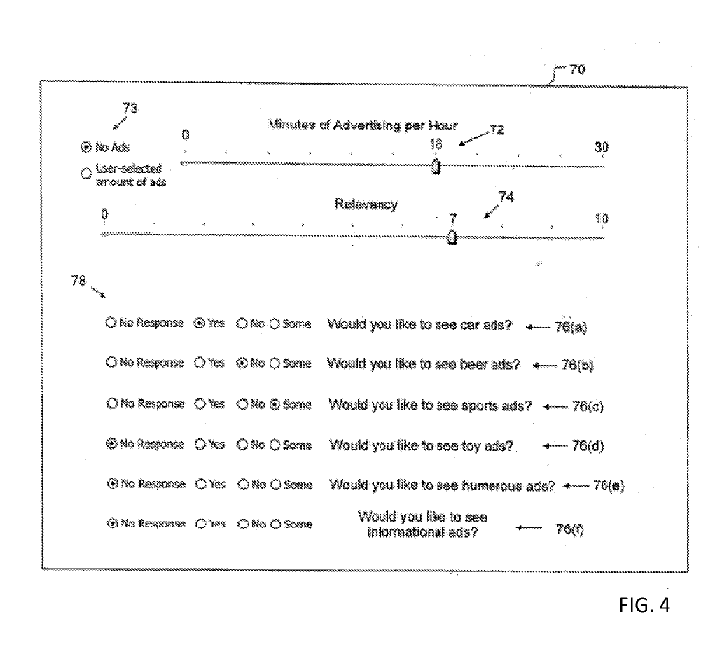

As discussed above, consumer's ever increasing access to digital content combined with businesses that leverage leveraging advertisements creates an apathetic consumer environment whereby consumers or viewers of advertisements often do not pay attention to the advertisements because the advertisements are too numerous and/or are of insufficient relevance to the viewer. Accordingly, the techniques disclosed herein particularly provide for advertisement filtering and targeting in an effort to overcome such apathetic consumer environment. Specifically, according to one embodiment of this disclosure, a graphical user interface (GUI) is presented to a viewer to query the viewer for preference settings. An example of such GUI is illustrated in FIG. 4.

FIG. 4 particularly depicts a graphical user interface (GUI) 70 displayed by display device 32. The GUI 70 presents a viewer with two slider controls 72, 74. One slider control 72 allows a viewer to choose an amount of advertising to be displayed per hour. As depicted, the viewer may select between 0 and 30 minutes of advertising per hour. The default setting of 18 minutes is currently selected. In an alternative embodiment the slider control 72 may instead control the number of banner advertisements 66 to be displayed on a web page 62. The GUI may also contains a set of radio buttons 73 that allows the viewer to select either completely advertising-free programming or an amount of advertising as defined by slider control 72.

The GUI may also contain a set of questions 76 about what kinds of advertisements the viewer wishes to see. Each question 76 is accompanied by a set of radio buttons 78 indicating the viewer's response. The default setting is “No response.” Additionally, the viewer may select “Yes,” “No,” or “Some.” For example, with respect to question 76(a), if the viewer indicates “Yes,” then the viewer has indicated a preference for seeing car advertisements. As an additional example, with respect to question 76(b), if the viewer indicates “No,” then the viewer has indicated a preference for NOT seeing beer advertisements. As an additional example, with respect to question 76(c), if the viewer indicates “Some,” then the viewer has indicated that some sports advertisements are desired, while other are not. In such a case, the GUI 70 may then proceed to present additional questions to the viewer. For example, the GUI 70 may ask if the viewer would like to see baseball ads, basketball ads, hockey ads, football ads, soccer ads, ads for non-traditional sports, and/or ads for sports fantasy camps. It should be understood that the specific questions 76 depicted in FIG. 4 and described above are examples only. Different questions about different advertising preferences may instead be asked.

The second slider 74 allows a user to choose a relevancy threshold setting for advertising provision. The viewer may select a relevancy threshold setting between 0 and 10. The default setting of 7 is currently selected. The relevancy threshold setting indicates how closely the viewer's preferences for specific types of advertising are to be followed. As is well-known in the art, a relevance score may be calculated for any particular advertisement (based on characteristics associated with the advertisement and the viewer's preferences). If such a score is calculated on a 10-point scale, then the relevancy threshold setting indicates that only advertisements with relevance scores exceeding the relevancy threshold setting are to be shown to the user. Thus a high relevancy threshold setting indicates that the viewer is not willing to tolerate any (or at most a few) advertisements of a type that the viewer has indicated a preference against seeing, while a low relevancy threshold setting indicates that the viewer is willing to tolerate more advertisements that the viewer has not confirmed interest in.

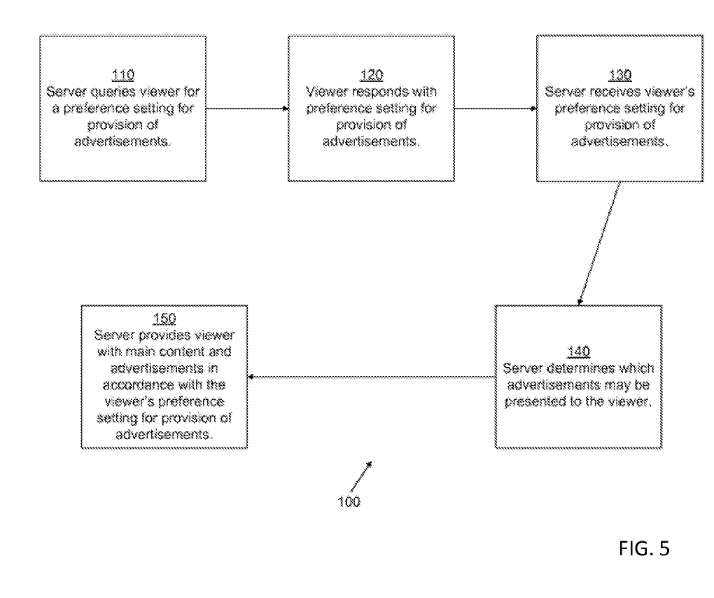

FIG. 5 depicts a method 100 to perform advertisement filtering and targeting techniques using, for example, the system of FIG. 1.

For example, in step 110, server 38 queries the user or viewer associated with display 32 and/or terminal device 34. Typically, the server 38 queries the viewer via a GUI, such as GUI 70 described above with respect to FIG. 4. The query solicits a preference setting from the viewer for provision of advertisements (e.g., options described with respect to GUI 70 above). Notably, in some embodiments, the terminal device 34 can query the viewer (e.g., in conjunction with server 38 and/or independent from server 38).

In step 120, the viewer submits a response to the query by selecting a preference setting for provision of advertisements. The response is further received by the terminal device 34 and/or server 38 (step 130). In one embodiment, this preference setting represents an amount of advertising to be shown per hour in a video program (or, alternatively, an amount of banner advertisements to be placed on a web page) as communicated, for example, by the first slider 72 and the set of radio buttons 73. In another embodiment this preference setting represents an amount of advertising to be shown prior to the viewer being permitted to view any main content, as for example on a web page.

In yet another embodiment, this preference setting is a relevancy threshold setting. In one embodiment, the relevancy threshold setting is used in conjunction with answers to questions 76 received by the GUI 70 via radio buttons 78. In another embodiment, the relevancy threshold setting is used in conjunction with other data received by the server 38 about the viewer's viewing habits, which allow the server 38 to determine how relevant certain advertisements may be.

In some embodiments, in exchange for the viewer selecting to view more advertisements, the viewer is provided with compensation. Similarly, in some embodiment, in exchange for the viewer selecting a lower relevancy threshold setting, the viewer is provided with compensation.

In one embodiment, the compensation is provided to the viewer by altering the viewer's subscription fee. For example, suppose a cable operator typically charges a subscriber $50 per month for cable VoD service. This is the subscription fee if the subscriber views the default 18 minutes per hour of advertisements. However, if the subscriber chooses to view 25 minutes per hour of advertisements, then the cable operator will only charge $30 per month. Alternatively, if the subscriber wishes to view only 10 minutes of advertisements per hour, the fee might increase to $70 per month. Or, if the viewer desires to see no advertisements at all, the fee might climb to $150 per month. Similarly, the $50 monthly fee assumes a relevancy threshold setting of, for example, 7. If the subscriber chooses a higher relevancy threshold setting, such as 9, then the fee might increase to $75 per month. Or, if the subscriber chooses a lower relevancy threshold setting, such as 4, then the fee might decrease to $25 per month.

In one embodiment, the viewer may change his or her responses to the queries on a temporary basis. Thus, while the viewer might ordinarily desire to see 18 minutes of advertising per hour for a standard $50 subscription fee, one evening the viewer might decide he or she would like to watch a movie commercial free. The fee for applying that viewer preference to one movie might be an additional $3 added to the monthly subscription fee. The user may similarly alter the relevancy threshold setting on a temporary basis.

In another embodiment, the compensation is provided to the viewer by providing the user with tradable credits. For example, a cable operator may charge $50 per month for standard VoD service, this service including the ability to watch 10 standard movies per month, plus 10 tradable credits per month. The viewer may trade a credit for the right to watch one additional standard movie. Or the viewer may trade two credits for the right to watch a “premium” movie (such as a new release). The user is able to earn additional credits for watching additional movies per month if the user agrees to watch additional advertisements. Thus, if the viewer chooses to view 25 minutes of advertising per hour instead of the default 18 minutes, then the cable operator may increase the number of credits provided to the viewer each month to 15 credits. Or, if the viewer chooses to view only 10 minutes of advertising per hour instead of the default 18 minutes, then the cable operator may decrease the number of credits provided to the viewer each month to 5 credits. If on one occasion, the viewer decides to watch a movie completely commercial-free, the cable operator may deduct 1 credit from the viewer's account. If on another occasion, the viewer decides to watch a movie with 30 minutes per hour of advertising, the cable operator may add 1 extra credit to the viewer's account. The user may similarly alter the relevancy threshold setting in order to receive tradable credits.

In step 140, the server 38 determines which advertisements 42 may be presented to the viewer. In particular, this may be done by assigning to each advertisement 42 within the database 40 a score indicating how relevant each advertisement 42 is to the viewer. This assignment of score is well-known in the art, and it may be done by any method. The relevancy score may be calculated with respect to viewer responses to questions 76, or it may be calculated with respect to data mined from the viewer's computer or other data mined about the viewer's habits (for example, what kind of main content the viewer regularly views, what kinds of product the viewer buys online, etc.). The server then marks all advertisements 42 whose score equals or exceeds the relevancy threshold setting received from the user (from slider 74 of the GUI 70) as potential advertisements to display to the viewer, forming a pool of potential advertisements.

In step 150, the server 38 retrieves main content (e.g., from database 40) and sends such main content to the viewer (e.g., transmits video content data to terminal device 34 and/or display 32 for subsequent display to the viewer). In addition to the main content, the server 38 also retrieves advertisements 42 selected from the pool of potential advertisements to the viewer. In one embodiment, the main content is Video on Demand (VoD) content requested by the user. In such a case, the server 38 sends video advertisements to the viewer interspersed with the VoD content. The VoD content may have pre-assigned break-points during which advertisements may be inserted, or alternatively, break-points may be determined on the fly. In one embodiment, the number of break-points may depend on a user selection. In another embodiment, a break-point may occur upon the occurrence of a triggering event (such as, for example, the appearance on the screen of a particular actor). The amount of advertising displayed during each break-point depends on the number of minutes of advertising the user wishes to see per hour as selected in slider 72 of the GUI. The specific video advertisements presented are chosen from the pool of potential advertisements. This is typically done according to a provider-specific advertisement selection algorithm. This embodiment may be performed over a cable television network having VoD support. It may also be performed over a computer network, where the server 38 provides VoD video clips across the computer network to the viewer's computer for display in a window on the computer monitor.

In another embodiment, the main content is live television content (excluding the advertisements). Such live television content is broadcast from a television station and received by the server 38. In such a case, the server 38 forwards the live television content to the viewer, but sends video advertisements 56 to the viewer in place of the advertisements which are contained on the live television broadcast from the television station. In such a case, the server ignores the number of minutes of advertising the user wishes to see per hour as selected in slider 72 of the GUI (in some embodiments, the GUI 70 refrains from presenting slider 72 to the viewer at all). The specific video advertisements 56 presented are chosen from the pool of potential advertisements.

In another embodiment, the main content is the body of a web page. In such a case, the server 38 sends the web page to the viewer with embedded banner advertisements 66. The number of embedded banner advertisements 66 depends on the number of banner advertisements 66 the viewer wishes to see as selected in slider 72 of the GUI. The specific banner advertisements 66 presented are chosen from the pool of potential advertisements. This embodiment may be performed over a computer network 36, where the server 38 provides web pages across the computer network to the viewer's computer for display in a browser window 60 on the computer monitor.

In another embodiment, the main content may either be the body of a web page or it may be video content. Before the server 38 sends the main content to the viewer, however, an amount of advertising (pre-selected by the viewer) is displayed. In one embodiment, this advertising contains video advertisements displayed for a fixed amount of time. In another embodiment, this advertising contains advertisements displayed on a web page for a fixed amount of time. The amount of advertising shown depends on the number of amount of advertising the viewer wishes to see as selected in a slider of the GUI 70. The specific advertisements presented are chosen from the pool of potential advertisements.

In one embodiment, after a particular advertisement 42 is shown to the viewer, the viewer may decide that he or she does not wish to see that particular advertisement 42 again. In such a case, the viewer may click on the undesired advertisement 42 and send a response to the server 38 indicating not to play that advertisement 42 again. That advertisement 42 is then removed from the pool of potential advertisements.

In another embodiment, a viewer may fast-forward through the advertisement portion 56 of a video if the viewer does not wish to see that particular advertisement 42. In such a case, the server 38 may tag that particular advertisement 42 so as not to display that advertisement 42 to the viewer again. That advertisement 42 is then removed from the pool of potential advertisements. Alternatively, the advertisement 42 may only be removed after it has been fast-forwarded through several times, so as to increase confidence that the viewer does not want to see that advertisement 42.

Similarly, in other embodiments, a viewer may otherwise implicitly indicate that a particular advertisement 42 should not be shown again. For example, while watching live television, the viewer may change the channel or activate an Electronic Program Guide every time a particular advertisement 42 is shown. Once the channel is changed away from the particular undesired advertisement 42 (these channel changes may be additive with fast forwards as well) several times, that advertisement 42 is then removed from the pool of potential advertisements.

Illustratively, the techniques described above may be performed by hardware, software, and/or firmware, such as in accordance with the terminal device 34, display 32, and server 38, as described above. In particular, server 38 and/or terminal device 34 may contain computer executable instructions executed by one or more processors (e.g., processor 41, an independent processor of network interfaces 39, and the like) to perform functions relating to the advertisement filtering and targeting techniques described herein.

While various embodiments that provide for filtering and targeting advertisements for users/viewers have been particularly shown and described, it will be understood by those skilled in the art that various changes in form and details may be made therein without departing from the spirit and scope of the invention as defined by the appended claims. For example, the embodiments have been shown and described herein with relation to a terminal device/display (e.g., computers/tablets/mobile devices, etc.) and a server 38. However, the embodiments in their broader sense are not as limited, and may, in fact, be used with any number of users/devices and the like. Further, certain embodiments were described as operating over a network, however such network is not needed—e.g., server 38 could be an application residing on the terminal device. In such a case, the advertisements would be transmitted to display 32 (e.g., presented to the viewer) without network 36, and the queries and responses may be locally transmitted and received by terminal device 34 as well. Moreover, although server 38 was described as containing an advertisement database 40, server 38 may not house the database 40—instead, database 40 may be stored on other computers connected to the same network 36 (e.g., in a distributed computing environment, etc.).

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium, devices, and memories (e.g., disks/CDs/RAM/EEPROM/etc.) having program instructions executing on a computer, hardware, firmware, or a combination thereof. Further, methods describing the various functions and techniques described herein can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on. In addition, devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example. Instructions, media for conveying such instructions, computing resources for executing them, and other structures for supporting such computing resources are means for providing the functions described in these disclosures. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method for targeting and filtering advertisements in a communication network, the method comprising:
querying, by a processor, a viewer for a response indicating a preference setting for provision of advertisements;
receiving, by the processor, the response to the query indicating the preference setting for provision of advertisements, the preference setting including a relevancy threshold setting indicating how closely the viewer's preference for certain advertisements are to be followed and a set of preferences for advertisements of certain types; and
providing, by the processor, display content to a display device associated with the viewer, the display content including:
a first component having a main content portion; and
a second component distinct from the first component, the second component having advertisements that closely match the set of preferences for advertisements of certain types when the relevancy threshold setting is high, and advertisements that less closely match the set of preference for advertisements of certain types when the relevancy threshold setting is low.

2. A method as in claim 1, further comprising:
receiving, by the processor, a variable fee from the viewer, an amount of the fee varying with the relevancy threshold setting.

3. A method as in claim 1, further comprising:
providing, by the processor, the viewer with compensation for selecting a lower relevancy threshold setting, an amount of the compensation varying with the relevancy threshold setting.

4. A method as in claim 3, wherein providing the viewer with compensation further includes reducing a fee paid by the viewer for subscription-based content services.

5. A method as in claim 1, wherein the preference setting further includes a list of classes of advertisement types that the viewer wishes to see.

6. A method as in claim 1, wherein the preference setting includes an indication as to which specific advertisements the viewer does not wish to see, and wherein providing, by the processor, display content to the display device associated with the viewer further includes:
refraining from providing the specific advertisements the viewer does not wish to see; and
providing display content for other advertisements in place of the advertisements the viewer does not wish to see.

7. A method as in claim 1, wherein the set of preferences for advertisements of certain types includes data about the viewer's viewing habits.

8. A method as in claim 1, wherein providing the display content to the display device associated with the viewer further includes:
sending a video signal over a live television system, wherein:
the main content portion is live television content;
the advertising includes pre-recorded video advertisements; and
the first component and the second component are to be played at different times.

9. A method as in claim 1, wherein providing the display content to the display device associated with the viewer further includes:
sending a digital video signal over a computer network, wherein:
the main content portion is viewer-selected video content;
the advertising includes video advertisements; and
the first component and the second component are to be played at different times.

10. A method as in claim 1, wherein providing the display content to the display device associated with the viewer further includes:
sending a video signal over a television-based video-on-demand system,
wherein:
the main content portion is viewer-selected video content;
the advertising includes video advertisements; and
the first component and the second component are to be played at different times.

11. A method as in claim 1, wherein providing the display content to the display device associated with the viewer further includes:
sending a web page over a computer network, wherein:
the main content portion is the body of a web page having viewer selected content;
the advertising includes banner advertisements; and
the first component and the second component occupy different portions of the web page.

12. A method as in claim 1, further comprising:
providing, by the processor, a set of questions to the a display device associated with the viewer, the set of questions include preferences for advertisements of certain classes, wherein providing the set of questions includes:
for each class of advertisement, presenting the viewer with an option to select between (a) categorically being willing to see advertisements of that class, (b) categorically being unwilling to see advertisements of that class, and (c) being willing to see some but not all advertisements of that class, and
for each class of advertisement that the viewer indicates that he is willing to see some but not all advertisements of that class, presenting the viewer with a supplemental set of questions regarding whether the viewer is willing to see a plurality of subclasses of advertisements within that class; and
wherein, the set of preferences for advertisements of certain types includes answers to the set of questions and the supplemental set of questions.

13. A method as in claim 1, wherein receiving the response to the query indicating the preference setting for provision of advertisements further includes:
receiving, at a first time, a first generally-applicable response to the query; and
receiving, at a second time after the first time, a second response to the query that is only applicable for a temporary period.

14. An apparatus comprising:
one or more network interfaces that communicate with in a communication network;
a processor coupled to the network interfaces and adapted to execute one or more processes; and
a memory configured to store a process executable by the processor, the process when executed operable to:
query a user over the communication for a response indicating a preference setting for provision of advertisements;
receive from the user, over the communication network, a response to the query indicating the preference setting for provision of advertisements, the preference setting including a relevancy threshold setting indicating how closely the viewer's preference for certain advertisements are to be followed and a set of preferences for advertisements of certain types; and
provide to the user, over the communication network display content to a display device associated with the user, the display content including:
a first component having a main content portion; and
a second component distinct from the first component, the second component having advertisements that closely match the set of preferences for advertisements of certain types when the relevancy threshold setting is high, and advertisements that less closely match the set of preference for advertisements of certain types when the relevancy threshold setting is low.

15. An apparatus as in claim 14, wherein the process, when executed, is further operable to:
provide to the user a set of questions about preferences for advertisements of certain classes, wherein providing the set of questions includes:
for each class of advertisement, presenting the user with an option to select between (a) categorically being willing to see advertisements of that class, (b) categorically being unwilling to see advertisements of that class, and (c) being willing to see some but not all advertisements of that class; and
for each class of advertisement that the user indicates that he is willing to see some but not all advertisements of that class, presenting the user with a supplemental set of questions regarding whether the user is willing to see a plurality of subclasses of advertisements within that class; and
wherein the set of preferences for advertisements of certain types includes answers to the set of questions and the supplemental set of questions.

16. An apparatus as in claim 14, wherein, the process, when executed to receive from the user the response to the query indicating the preference setting for provision of advertisements, is further operable to:
receive, at a first time, a first generally-applicable response to the query; and
receive, at a second time after the first time, a second response to the query that is only applicable for a temporary period.

17. In a computerized device, a method comprising:
querying, by a processor, a viewer for a set of preferences for advertisements of certain types;
receiving, by the processor, a response to the query for the set of preferences for advertisements of certain types, the response including a relevancy threshold setting indicating how closely the viewer's preference for certain advertisements are to be followed; and
providing, by the processor, display content to a display device associated with the viewer, the display content including:
a first component having a main content portion; and
a second component consisting of one or more advertisements that (a) closely match the viewer's set of preferences for advertisements of certain types when the relevancy threshold setting is high and (b) that less closely match the viewer's set of preferences certain advertisements of certain types when the relevancy threshold setting is low.

18. A method as in claim 17, wherein querying the viewer for the set of preferences for advertisements of certain types further includes providing a set of questions about preferences for advertisements of certain classes, including:
for each class of advertisement, presenting the viewer with an option to select between (a) categorically being willing to see advertisements of that class, (b) categorically being unwilling to see advertisements of that class, and (c) being willing to see some but not all advertisements of that class; and
for each class of advertisement that the viewer indicates that he is willing to see some but not all advertisements of that class, presenting the viewer with a supplemental set of questions regarding whether the viewer is willing to see a plurality of subclasses of advertisements within that class; and
wherein, the set of preferences for advertisements of certain types includes answers to the set of questions and the supplemental set of questions.
